(19) United States
(12) Patent Application Publication
(10) Pub. No.: US 2004/0102190 A1
(43) Pub. Date: May 27, 2004

(54) Method and device for producing data technical services using distributed wireless architecture (dwa)

(76) Inventors: Pepe Forsberg, Helsinki (FI); Ari Laurila, Karkkila (FI); Jussi Perkio, Helsinki (FI); Kai Solehmainen, Helsinki (FI)

Correspondence Address: MERCHANT & GOULD PC, P.O. BOX 2903, MINNEAPOLIS, MN, 55402-0903, US

(21) Appl. No.: 10/344,657

(22) PCT Filed: Aug. 1, 2001
(86) PCT No.: PCT/FI01/00690

(30) Foreign Application Priority Data
Aug. 15, 2000 (FI) 2000 1976

(51) Int. Cl. H04M 3/00

(52) U.S. Cl. 455/422.1; 455/418; 455/445

(57) ABSTRACT

The invention relates to a method and an apparatus for producing data technical services by using a distributed wireless architecture. The invention enables a mobile data technical device to be exploited more effectively than before. The main system and a mobile wireless device are both provided with processing environments identical to each other or adapted from the other. The wireless device and the main system are capable of switching the processing site of an application protocol between the wireless device and the main system. Each section of the system is able to operate independently without a mutual communication link and to distribute, as required by a particular application, the processing of data between the system sections while the communication link exits.

The invention relates to a method and an apparatus, which are capable of enhancing the use of a wireless system, such as for example an independent device (hereinafter a wireless device) connected to a more extensive system by means of a portable phone or the like device or some other communication link, as a data technical terminal unit.

The extensive use of a wireless device as a data technical terminal unit is restricted both by physical limitations resulting from the special character of the device and relating to terminal technology and a radio link used for data transmission and by the operating methods of data systems and networks. With regard to technical limitations of a wireless device, the ultimate ones are power consumption and a small size. Power consumption limits the available computing capacity due to processor technology, which in turn limits the functional diversification of wireless devices and the augmentation of applicability thereof, for example by means of a graphical user interface. On the other hand, a small size causes problems, regarding for example the practical configuration of a power supply and a display unit.

In available wireless systems, the wireless device comprises an independent entity, which can be connected across a transmission path to a system (hereinafter a main system) operating at the other end of a communication link. When a wireless device is operated by a user, it is the responsibility of this device to perform independently all functions required for implementing a service at the terminal unit end. This implies that the wireless device itself must process all the information which is required for example for displaying text on the screen of the device. In some systems, the main systen may perform some degree of preprocessing, but even then th re is a limitation constitued by architectural (e.g. a different order of bit transmission, a different mod of data display) and functional (e.g. no exact status information) discrepancies between a wireless device and a main system. The main system does not have exact information regarding the properties or functional status of a wireless device performing the function of a terminal unit and, hence, the main system is not capable of producing information such that the wireless device could exploit as such, without further processing. Due to the operating mode of currently available systems, the limitations relating to the computing capacity of wireless devices restrain the functional diversification of wireless devices, for example in terms of graphics.

Neither do the currently available wireless system enable the applications used in wireless devices to operate independently in a main system, when the communication to a terminal unit is disconnected. Thus, it is not easy to create applications, by which it is possible, for example, to collect information from data networks even when there is no communication link and to transfer the information to a wireless device as the communication link is established again. It is possible to implement the above condition in the available systems as a special service of the main system, but such a capability cannot be provided by a party working on the application for a wireless device.

It is an object of this invention to provide a method and an apparatus, whereby it is possible to eliminate or alleviate the above restraints regarding the operation of a wireless device in such a way that the diversity of services provided by a wireless device can be further expanded from the present. In addition, the invention can be used for distributing applications used in wireless devices to operate as the case may be on the side of a terminal unit and/or a main system, and thus for developing services more versatile than before.

This object can be accomplished according to this invention by distributing the implementation of a wireless application between the processing environment of an actual wireless device and a processing environment built in the main system and closely resembling or matching the processing environment of the wireless device. The processing environment of a main system may also encompass the processing environment of a wireless device as such. This can be achieved, for example, by using the same processor or an adapted processor and the same or an adapted operating system both in a wireless device and in a main system. Thus, an application can be conveniently divided, as required by the application in question, into sections operating both in a wireless device and in a main system, which can be in communication and in a highly effective cooperation with each other. Consequently, the power consumption of a wireless device can be reduced by making use of the computing capacity of a powerful main system, whenever that is possible. The capacity observed by the user of a wireless device can be increased without actually augmenting the real computing capacity of the wireless device.

Data transmission can be performed effectively by means of a close-to-hardware protocol for an efficient exploitation of the available data transfer capacity. The contents of transferred data can be maintained at a very low level of abstraction in order to require no extra data processing and to have an effective data transfer. In addition, the transfer of data can be effected by using the compression of data, if this is not implemented by the current data bus itself.

The presently discussed distributed wireless architecture enables the development of a wireless application into a duplex configuration in every situation without having to separately build in the main system a special service, for example on the part of a telephone operator. However, the individual sections of an application function in such a close cooperation that referring to the same as a single entity is justified. By virtue of the system, the external application level interface of a wireless device expands to a main system instead of just the wireless device. The system also enables applications which function in a main system while communication to the actual wireless device is disconnected.

More specifically, a distributed wireless architecture of the invention is characterized by what is set forth in the characterizing clause of claim 1.

The invention will now be described in more detail with reference made to the accompanying drawings, in which:

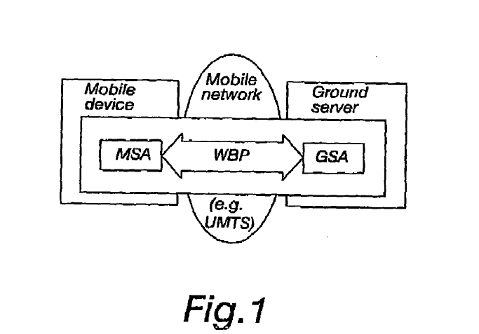

FIG. 1 shows schematically an available mobile phone system and a distributed wireless architecture; and

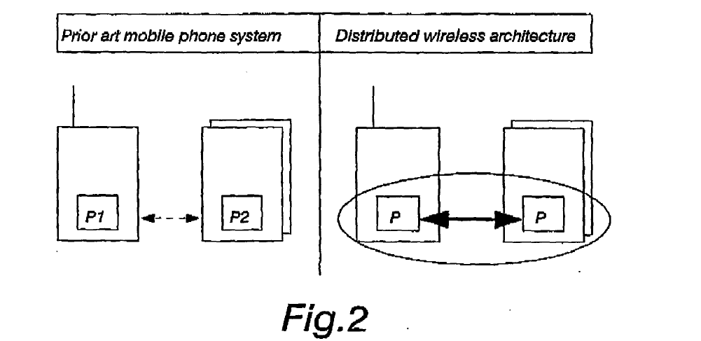

FIG. 2 shows schematically one practical embodiment for an apparatus and a system intended for use in the invention.

In the currently available wireless telephone system, a main system located on the ground and a mobile wireless device are provided with different architectures regarding data systems. This restricts the mutual distribution of data processing, data management, and data transmission between these systems. In the present invention, both the main system and the wireless device are provided with a common processing environment, whereby the data processing can be distributed between the systems substantially more freely than before. FIG. 1 illustrates schematically the basic difference between currently available mobile phone systems and a wireless communication system making use of an architecture of this invention.

In the inventive architecture, a wireless application can be divided, as shown in FIG. 2, for a section implemented in a main system (GSA Ground Side Agent) and a section implemented in a wireless device (WSA, Wireless Side Agent). These sections of an application converse with each other by using a low abstraction level data transfer protocol (WBP, Wireless Binary Protocol).

Depending on the appilcation, data processing can be performed for the most part either in a main system or in a wireless device. The wireless device may function as nothing more than a terminal unit, in which case it only provides a display screen or a loudspeaker with data processed earlier by a main system. Thus, the wireless device maintains its power consumption as low as possible and a long effective operating time. On the other hand, some of the data processing can be conducted in a wireless device and some of it in a main system. For example, when producing 3-dimensional graphics for the screen of a wireless device, the main portion of data processing can be carried out in a main system and just the required portion in the wireless device. This serves to economiz the memory and computing capacity of a wireless device. This released data processing capacity can be re-exploited, for example as a reduced power consumption.

If communication between a wireless device and a main system is broken, each section of the system functions as a self-sufficient unit. As a practical example, this type of situation may arise for example in a long road tunnel, in a hospital or some other place where the use of a radio transmitter or receiver is prohibited or restricted. The invention enables the operation of a few processes in a totally wireless device. Such processes may include e.g. a calendar, a telephone directory, and a memo book. On the other hand, some processes may only be active in the main system when there is no connection to the wireless device. Such processes may include e.g. internet search processes, uploading of files, and some network monitoring processes.

The invention enables the use of the same above-discussed system in a number of wireless devices. The user may have for example three separate devices, as required. A small, pocket-size unit primarily for telephone communication, a slightly larger unit for example for more effective memo book functions and a longer standby time, as well as a still larger and more powerful device with a more effective display and standby power for viewing a movie, for example. A common feature for the units is that they can be provided with the same invention-fulfilling component, by virtue of which the system is transparent for an application developer, such that the application developer need not be aware as to which section of the system carries out each section of the application. It Is not until during the processing of an application (i.e. in real time) that the sections of the application are distributed between a wireless device and a main system under the control of mutual communication between the wireless device and the main system. Thus, the system is capable, as required, of switching the code processing location between a wireless device and a main system. Therefor, the main system identifies features associated with the display andlor capacity of a wireless device and/or the functional status of a wir less device, and communicates with the wireless device in accordance with the identified features and/or the functional status.

The main system has its processing environment provided with processing time and processing space, as well as storage space, for carrying out the application protocol of a wireless device partially or completely in the processing environment of the main system.

1. A method for producing data technical services by using a distributed wireless architecture, which comprises a wireless device and a main system and in which an application or a section thereof can be processed in the wireless device and/or in the main system, characterized in that the wireless device or a section thereof and the main system or a section thereof are provided with processing environments which are identical or adapted from the other, or with another processing environment interpreting the same processible code, such that under the control of mutual communication the wireless device and the main system are capable of distributing the processing of a wireless application and/or of switching the processing site of an application protocol between the wireless device and the main system.

2. A method as set forth in claim 1, characterized in that the wireless device or a section thereof and the main system or a section thereof are provided with processors which are identical or adapted from the other.

3. A method as set forth in claim 1 or 2, characterized in that the wireless device and the main system are provided with operating systems which are identical or adapted from the other.

4. A method as set forth in claim 1, characterized in that the wireless application or a section thereof is processed in the wireless device and/or in the main system without having a communication link therebetween in operation.

5. A method as set forth in claim 1, characterized in that the application exploits the main system services for intra-application data processing.

6. A method as set forth in any of claims 1-5, characterized in that the application or a section thereof is processed both in the wireless device and in the main system.

7. A method as set forth in any of claims 1-6, characterized in that the main system identifies features associated with the display and/or the capacity of a wireless device and/or the functional status of a wireless device, and communicates with the wireless device in accordance with the identified features and/or the functional status.

8. An apparatus for producing data technical services by using a distributed wireless architecture, which comprises a wireless device and a main system and in which an application or a section thereof can be processed in the wireless device and/or in the main system, characterized in that the wireless device or a section thereof and the main system or a section thereof have processing environments thereof adapted to each other in such a way that under the control of mutual communication the wireless device and the main system are capable of distributing the processing of a wireless application and/or of switching the processing site of an application protocol between the wireless device and the main system.

9. An apparatus as set forth in claim 8, characterized in that the wireless device or a section thereof and the main system or a section thereof are provided with processors which are identical or adapted from the other.

10. An apparatus as set forth in claim 8 or 9, characterized in that the wireless device or a section thereof and the main system or a section thereof are provided with operating systems which are identical or adapted from the other.

11. An apparatus as set forth in claim 8, characterized in that the wireless application or a section thereof is adapted to be processed in the wireless device and/or in the main system without having a communication link therebetween in operation.

12. An apparatus as set forth in any of claims 8-11, characterized in that the application or a section thereof can be processed both in the wireless device and in the main system, and furthermore the application or a section thereof can be processed optionally, depending on the application, either in the wireless device or in the main system.

13. An apparatus as set forth in any of claims 8 -12, characterized in that the main system has its processing environment provided with processing time and processing space, as well as storage space, for carrying out the application protocol of a wireless device partially or completely in the processing environment of the main system.
